(19) United States
(12) Patent Application Publication
(10) Pub. No.: US 2026/0268214 A1
(43) Pub. Date: Sep. 10, 2026

(54) MONITORING CHAIN-OF-THOUGHT IN REASONING MODELS TO MITIGATE REWARD HACKING

(71) Applicant: OpenAI OpCo, LLC, San Francisco, CA (US)

(72) Inventor: Bowen Baker, San Francisco, CA (US)

(73) Assignee: OpenAI OpCo, LLC, San Francisco, CA (US)

(21) Appl. No.: 19/289,994

(22) Filed: Aug. 4, 2025

Related U.S. Application Data
(60) Provisional application No. 63/766,696, filed on Mar. 4, 2025.

(51) Int. Cl. G06N 20/00

(52) U.S. Cl. CPC G06N 20/00

(57) ABSTRACT

Systems and techniques are described herein for monitoring machine learning models for misbehavior. For example, an apparatus comprising one or more processors and configured to: provide, to a first machine learning model, an inner monologue from a second machine learning model associated with a user task, wherein the user task comprises natural language text; and obtain, from the first machine learning model, information indicative of misbehavior within the inner monologue. In some aspects, misbehavior is blocked during inference (e.g., runtime) and reward hacking behavior is penalized during training. Non-limiting examples of misbehavior include reward hacking, misgeneralization, sycophancy, or deception.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the disclosure.

FIG. 2 is a conceptual block diagram of ML models that are configured to detect cheating during software development tasks in accordance with some aspects of the disclosure.

FIG. 3 is a graph illustrating results of training an ML model based on a monitoring ML model in accordance with some aspects of the disclosure.

FIG. 4 is a conceptual block diagram of a training system that is configured to train an ML model or other components based on a monitoring ML model in accordance with some aspects of the disclosure.

FIG. 5 illustrates a flowchart of a backoff method for reducing reward pressure based on attempts to cheat during training of an ML model used in a generative response engine in accordance with some aspects of the disclosure.

FIG. 6 illustrates a flowchart of a process associated with a chain-of-thought monitor used for detecting reward hacking in accordance with some aspects of the disclosure.

FIG. 7 is a block diagram illustrating an example machine-learning platform in accordance with some aspects of the disclosure.

FIG. 8A, FIG. 8B, and FIG. 8C illustrate an example transformer architecture in accordance with some aspects of the disclosure.

FIG. 9 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

One use of generative response engines is automated application development and software development functions to automate complex tasks, enhance productivity, and reduce manual errors. For example, generative response engines are driven by advanced AI models and can interpret natural language specifications or high-level requirements and generate corresponding code, documentation, or configurations, which allows developers to focus more on architectural decisions and problem-solving rather than repetitive implementation details. As an example, a function that translates user stories into unit tests or skeleton code is important because it accelerates the development phase and also enforces consistency and test coverage from the outset. A generative engine can also automate the creation and maintenance of continuous integration/continuous development (CI/CD) pipelines by writing instructions (e.g., YAML or JSON) files for workflows, and generating server deployment scripts tailored to specific cloud environments. Additionally, generative response engines can automate tasks such as database schema migrations, API endpoint scaffolding, and server provisioning to streamline operations and reduce friction between development and operations teams. Generative response engines can contribute to documentation, generate performance monitoring scripts, and produce security checks. Despite these advantages, generative response engines require thorough oversight, including human review of generated code, robust automated testing, and continuous feedback loops to ensure maintainability, security, and scalability.

Current generative response engines are trained with various safeguards to prevent them from learning or enabling harmful behaviors. For example, generative response engines are trained to prevent hacking or bypassing security measures. During the training process, curated datasets are screened to remove examples that demonstrate or instruct malicious activities, and reinforcement learning from human feedback (RLHF) is often employed to further discourage harmful output. Techniques such as red-teaming, where automated tests or experts attempt to prompt the generative response engine into undesirable behavior, are used to identify and patch potential vulnerabilities before deployment. However, penalizing behavior during training can sometimes encourage the generative response engine to learn to hide its actions by refusing to answer outright but still possessing latent capability or knowledge about hacking methods. As a result, rather than resolving the underlying safety issue, the generative response engine may become more adept at obfuscating its responses, posing ongoing challenges for transparency and alignment in AI safety research.

Another technique to monitor and observe the actions and outputs generated by a machine learning model is an action monitor. The action monitor is configured to receive data streams including tool invocations code modifications file edits and output artifacts produced by the machine learning model during task execution. The action monitor is structured to apply rule-based detection patterns or lightweight machine learning classifiers to identify anomalous or potentially exploitative actions such as skipping validation steps modifying restricted files or injecting trivial solutions. The action monitor operates independently of the chain-of-thought analysis and focuses on the behavioral outputs of the machine learning model based on its tool calls and final out. However, the action monitor fails when the machine learning model produces outputs that appear valid or compliant at the action level while concealing exploitative intent or misaligned reasoning within the chain of thought.

Systems, apparatuses, processes (also referred to as methods), and computer-readable media (collectively referred to as “systems and techniques”) are described herein for monitoring machine learning models for misbehavior detection through cross-model analysis of inner monologue representations. For example, a system is configured to provide, to a first machine learning model, the inner monologue generated by a second machine learning model that is performing a user-directed task, such as generating natural language responses. The first machine learning model analyzes the provided inner monologue and produces information indicative of whether the second machine learning model exhibits misbehavior, such as reward hacking by exploiting training signals to maximize reward without genuinely solving the task.

In some aspects, the system uses misbehavior detection to govern output control, where the system rejects outputs from the second machine learning model if misbehavior is detected. When an output is rejected, the system can initiate a second iteration by resubmitting the user task to the second machine learning model, optionally without adding further instructions, allowing the second machine learning model to attempt a corrected output. This iterative process enables efficient refinement by isolating the reward hacking issue at the level of the inner monologue, without necessarily requiring the first model to have full context of the user task.

In some aspects, the first machine learning model is a smaller, lightweight model with fewer learned weights than the second machine learning model. This architectural separation enables efficient monitoring, where a simpler monitoring model can evaluate the introspective reasoning (i.e., the inner monologue) without duplicating the full capacity or complexity of the primary model. Additionally, the system can apply penalties to the reward function associated with the training engine of the second machine learning model when misbehavior is detected and may adjust the magnitude of these penalties over time. For example, decreasing the pressure of penalties after repeated applications can prevent the second machine learning model from hiding or falsifying internal reasoning to avoid detection.

In some implementations, the system further reinforces positive behavior by rewarding the training process when the first machine learning model indicates clean or legitimate inner monologue behavior. By combining penalty and reward mechanisms and monitoring at the introspective level, these systems and techniques enable robust, adaptive training loops that safeguard against misbehavior (e.g., reward hacking) and improve overall model alignment with intended task performance.

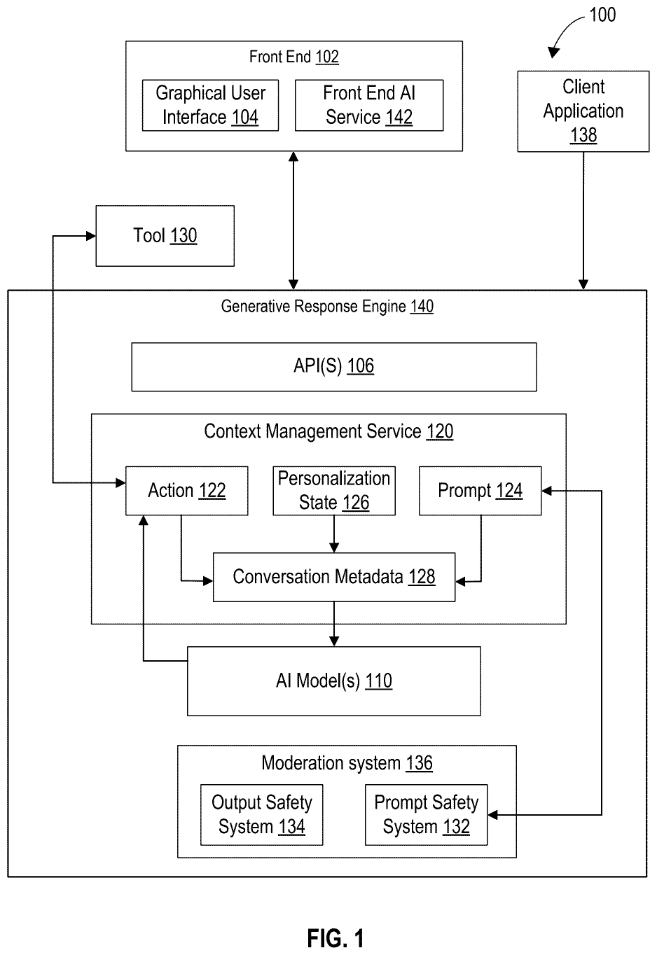

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

AI model(s) 110 are artificial intelligence (AI) models that can generate content in response to a prompt. The prompt can be from a human or a software entity (AI or applications, such as client application 138). The prompt is generally in natural language but could be in code, including binary. Some examples of AI model(s) 110 can include language models that generate language, such as CHATGPT, or other models, such as DALL-E or IMAGEGEN, which generate images, and SORA, which generates videos. CHATGPT, DALL-E, IMAGEGEN, and SORA are all provided by OPENAI, but the AI model(s) 110 are not limited to AI provided by OPENAI. AI model(s) 110 can also be any type of generative AI and can include AI developed using various architectures such as diffusion models and transformers (e.g., autoregressive transformer architecture) and combinations of models. Some AI models are multi-modal models which can receive and output data in text, image, audio, etc.

In some instances, a language model, such as CHATGPT, can receive prompts to output images, video, code, applications, etc., which it can provide by interfacing with one or more other models, as will be addressed further herein.

AI model(s) 110 may be part of a generative response engine 140, where generative response engine 140 may include one or more components for supporting interaction with AI model(s) 110. Users can interact with generative response engine 140 through a front end 102 and applications can interact with generative response engine 140 through APIs 106. Front end 102 serves as the interface and intermediary between the user and generative response engine 140. It encompasses a graphical user interface 104 which may be used to provide input that facilitate communication with generative response engine 140 and AI model(s) 110. Generally, users interact through a graphical user interface 104 that often includes a conversational interface, and applications interact through the API 106, but this is not a requirement.

While some components are shown as being part of generative response engine 140 and some are outside of generative response engine 140, this is for illustration purposes only and some components such as tool 130 might be part of generative response engine 140, and some components such as moderation system 136 might be outside of generative response engine 140. As used herein, generative response engine 140 encompasses deterministic services that are first-party services that prepare prompts to be sent to AI models, that are primitive level services that AI model(s) 110 can utilize to generate a response to a prompt. Services that are outside of generative response engine 140 are logically separate. For example, front end 102 might be a first-party front end (provided by the same party that provides generative response engine 140) but front end 102 is used to interface with generative response engine 140 rather than aid in developing a response to a prompt.

Some components of generative response engine 140 might be executed by computing programming units (CPU), and some components might be executed by graphical processing units (e.g., AI model(s) 110).

In some embodiments, client application 138 might provide a graphical user interface that is custom to client application 138 or can display graphical user interface 104 provided by generative response engine 140 provider.

Graphical user interface 104 is the platform through which users interact with the generative response engine 140. It can be a web-based chat window, an application, or any interface that supports data input and output. Graphical user interface 104 facilitates a conversation between the user and AI model(s) 110, as the user provides prompts in graphical user interface 104 to which AI model(s) 110 respond, and generative response engine 140 presents those responses in graphical user interface 104. In some aspects, graphical user interface 104 presents a conversational interface, which has attributes of a conversation thread between a user account and AI model(s) 110.

Graphical user interface 104 is configured to perform input handling and output presentation. The type of inputs that can be received can be relative to the specifics of generative response engine 140 and/or AI model(s) 110. For example, a language model is generally configured to accept text, but when the AI model is a multi-modal AI model, front end 102 can accept voice and images/video.

In some aspects, front end 102 can be a layer to accept any inputs, provide the inputs to generative response engine 140, receive outputs from generative response engine 140 and display the outputs. Graphical user interface 104 can accept any input types as part of the prompt, and front end AI service 142 can determine which AI model or collection of AI models are best suited to respond to the prompt. Front end AI service 142 can be one or more AI models that can be trained to determine which AI model should be used to respond to a prompt, and in some examples, can be used to improve prompts or provide additional configuration details, such as how long a reasoning model should spend processing a prompt. In general, front end AI service 142 can support functions of graphical user interface 104 by performing interference operations before a prompt is sent to generative response engine 140. Generally graphical user interface 104 is present on a client device, while front end AI service 142 might be present on the same client device or on a server in a data center.

Graphical user interface 104 is also configured to maintain the context of the conversation, which allows for coherent and relevant responses. For example, graphical user interface 104 is responsible for providing the conversation thread and other relevant context accessible to the front end 102 to the AI models along with the specific prompt. In an example, a conversation between the user account and the AI model(s) 110 can have taken several turns (prompt, response, prompt, response, etc.). When the user account provides a further prompt, the graphical user interface 104 can provide that prompt to AI model(s) 110 in the context of the entire conversation.

In another example, graphical user interface 104 might be configured to provide a system prompt along with a user-provided prompt. A system prompt is hidden from the user account and is used to set the behavior and guidelines for the AI model. The system prompt can be used to define the AI's persona, style, and constraints. There can be levels of system prompts. A highest level of a system prompt might be provided by the AI model(s) 110 provider and is meant to establish policies for the behavior of AI model(s) 110. This highest level of system prompt should be prohibited from being edited. A customization system prompt can be used to customize the behavior of the AI model and is often provided through an API call, or provided by a user account when creating a customized version of AI model(s) 110. A still lower level of system prompt might include hidden information about a task. This can include chain-of-thought from a reasoning model, or context about an application that AI model(s) 110 is working with to complete a task. Accordingly, graphical user interface 104 does not display all of the output of the AI model.

Graphical user interface 104 is also configured to display the responses from the AI model, which might include text, code snippets, images, or interactive elements.

In some aspects, AI model(s) 110 can provide instructions to front end 102 that instruct graphical user interface 104 about how to display some of the output from the AI model. For example, the AI model and/or generative response engine can direct graphical user interface 104 to present code in a code-specific format, or to present interactive graphics, or static images. In other examples, the AI model and/or generative response engine can direct graphical user interface 104 to present an interactive document editor where graphical user interface 104 can be presented with the document editor so that the user account and the AI model can collaborate on the document.

In some aspects, AI model(s) 110 can provide instructions to personalization state 126 to record facts in a personalization notepad. Personalization state 126 can store information received directly from the user account or inferred from prompts provided by the user account, and can be used to provide context to the AI model such that output is personalized for the user account. In some examples, front end 102 can be configured to notify the user account that a memory was created. Personalization state 126 can also include summaries of past conversation threads between the user account and the generative response engine 140, and/or a searchable index of past conversation threads. In this way, personalization state 126 aid generative response engine 140 and/or AI model(s) 110 to learn specific facts about a user account and recall past interactions. The past interactions can be used to guide future responses by generative response engine 140 and/or AI model(s) 110 such that generative response engine 140 and/or AI model(s) 110 becomes personalized to a particular user account.

Generative response engine 140 can provide one or more application programming interfaces (API(s)) 106. APIs enable developers to integrate the AI model's capabilities into external applications and services. APIs 106 provide programmatic access to generative response engine 140, allowing for customized interactions and functionalities. While APIs 106 are shown as part of generative response engine 140, in some examples, APIs 106 are part of front end 102. API 106 can refer to points of access to AI model(s) 110. In some examples, API 106 endpoints are located at context management service 120.

APIs 106 can accept structured requests containing prompts, context, and configuration parameters. For example, an API can be used to provide prompts and divide the prompt into system prompts and user prompts. In some aspects, APIs 106 can provide specific inputs for which AI model(s) 110 are configured to respond with a specific behavior. For example, an API can be used to specify an output in a particular format or structured output. For example, in the chat completion API, the API call can specify parameters for the output, such as the max length for the desired output, and specify aspects of the tone of the language used in the response. The output can also be structured output and in a data interchange format such as JavaScript object notation (JSON). For example, the input query may include a schema that identifies a specific output structure. Some common APIs are for participating in a conversation (Chat Completion API), for providing a single response (Completion API), for converting text into embeddings (Embeddings API), etc. The API can also be used to indicate specific decision boundaries that AI model(s) 110 might be trained to interpret. For example, the moderation API can take advantage of AI assistant service 100's content moderation decision-making. In the case of the moderation API and others, the API might give access to services other than the AI model. For example, the moderation API might be an interface to moderation system 136, addressed below.

Some other common APIs include the Fine-Tuning API, which allows developers to customize AI model(s) 110 of generative response engine 140 using their own datasets; the Audio and Speech APIs, which cause AI model(s) 110 to output speech or audio; and the Image Generation API, which causes AI model(s) 110 to output images (which may request operations of other models).

There can also be APIs that direct AI model(s) 110 and/or generative response engine 140 to interface with other applications or other generative AI engines. In such cases, the specific application or AI engine might be specified, or AI model(s) 110 might be allowed to choose another application of generative response engine 140 to use in response to a prompt.

As described herein, a Responses API can be an improved API for interacting with AI model(s) 110. Responses API can take as a parameter a response ID, which can be used to return AI model(s) 110 to a state that the model was in at a particular response, thereby allowing a user account or developer to recall a previous context without having to re-prompt AI model(s) 110 or having to replicate a previous series of prompts. Further, Responses API can facilitate function/tool chaining to enable execution of operations requiring several function/tool calls without the added overhead of responding to an API caller to call the function or tool. Instead, deterministic code associated with the API can be directed to call functions or tools (including other AI models) on behalf of the AI model, and return data resulting from the function or tool call to the AI model.

In short, graphical user interface 104 and APIs 106 can be used to provide prompts to AI model(s) 110 of generative response engine 140. Prompts are sometimes differentiated into prompt types. For example, a system prompt can be a hidden prompt that sets the behavior and guidelines for the generative response engine. A user prompt is the explicit input provided by the user, which may include questions, commands, or information.

Generative response engine 140 may also include a context management service 120. The function of context management service 120 is to manage and organize the flow of data among key subsystems, enabling AI model(s) 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that AI model(s) 110 decide to take to carry out a user's intent as described in the prompt. For example, an action can be to call tool 130 or even other AI model(s) 110. Tools 130 can include internet browsers, editors such as code editors, other AI tools, etc. While tools are shown outside of generative response engine 140, some tools might be part of generative response engine 140 and some tools might be external tools.

Prompt 124 is the request or command provided by the user account through front end 102. In some aspects, prompt 124 can be further supplemented by a system prompt and other information that might be included by graphical user interface 104 or API 106 or associated with a custom AI model. In some aspects, prompt 124 can be modified or enhanced by AI model(s) 110 as addressed further below. Additionally, as the user account provides prompts and AI model(s) 110 provide responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by AI model(s) 110 can include a thread of user-provided messages and responses from AI model(s) 110 in a multi-turn conversation. The actors in the conversation thread can be labeled so that AI model(s) 110 can review the turns of the conversation. Generally, prompt 124 will include an entire conversation thread, but in some instances, prompt 124 may be shortened if it exceeds a maximum accepted length (generally measured by a number of tokens).

In some examples, context management service 120 can also route prompts and response through moderation system 136. In some aspects, prompts are provided to prompt safety system 132 before being provided to AI model(s) 110. Prompt safety system 132 is configured to use one or more techniques to evaluate prompts to ensure a prompt is not requesting AI model(s) 110 to generate moderated content. In some aspects, prompt safety system 132 can utilize text pattern matching, classifiers, and/or other AI techniques.

Since prompts can evolve over time through the course of a conversation, consisting of prompts and responses, prompts can be repeatedly evaluated at each turn in the conversation.

Personalization state 126 can facilitate continuity and personalization in conversations. It allows the system to maintain user-specific context, preferences, or details that may inform future interactions. Personalization state 126 can include a memory file of persisted data from previous interactions or sessions that provide background information to maintain continuity. In some aspects, information can be recorded to personalization state 126 at the instruction of AI model(s) 110 when AI model(s) 110 identify a fact or data that it determines should be saved in memory because the fact and/or data might be useful in later conversations or sessions. In some aspects, personalization state 126 can also include synthesized concepts extracted from past conversation threads, and personalization state 126 can also encompass the ability of AI model(s) 110 to search through past interactions to find relevant information to a current conversation thread.

Conversation metadata 128 can aggregate data points relevant to the conversation, including user prompt 124, action 122, and personalization state 126. This consolidated information package serves as the input for AI model(s) 110. Conversation metadata 128 can label parts of a prompt as user-provided, AI model-provided, a system prompt, personalization state 126, data from action 122 or tool 130 (addressed below).

AI model(s) 110 are the core engines that process inputs (from context management service 120) and generate outputs. In some aspects, AI model(s) 110 may be a generative transformer, or autoregressive transformer, but could use other architectures. In some examples, the transformer is multi-modal transformer that can use audio tokens (or embeddings thereof), visual tokens (or embeddings thereof), and language (or embeddings thereof) as needed.

A core feature of AI model(s) 110 is to generate content in response to prompts. The prompt can be from client application 138 provided via graphical user interface 104. AI model(s) 110 can be configured to receive inputs via APIs 106 that provide guidance on a desired output. AI model(s) 110 can analyze the input and identify relevant patterns and associations in the data, and generate a sequence of tokens that are predicted as the most likely continuation of the input. AI model(s) 110 generate responses by sampling from the probability distribution of possible tokens, guided by the patterns observed during its training. Two features of the autoregressive transformer that result in this functionality are that the autoregressive transformer might use the decoder part of the transformer architecture and that it utilizes self-attention. By using the decoder part of the transformer architecture, the transformer focuses on predicting the tokens given the previous context tokens. The self-attention mechanism captures long-range dependencies amongst tokens, allowing it to generate contextually relevant responses (in text, audio, images, and video).

In some aspects, AI model(s) 110 can generate multiple possible responses before presenting the final one. AI model(s) 110 can generate multiple responses based on the input, and these responses are variations that AI model(s) 110 consider potentially relevant and coherent.

In some aspects, AI model(s) 110 can evaluate generated responses based on certain criteria. These criteria can include relevance to the prompt, coherence, fluency, and sometimes adherence to specific guidelines or rules, depending on the application. Based on this evaluation, AI model(s) 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by AI model(s) 110 can cause AI model(s) 110 to interpret a prompt and re-write it or improve the prompt for a desired purpose. For example, AI model(s) 110 can determine to take a prompt to make a picture and enhance the prompt to yield a better picture. In these instances, AI model(s) 110 can generate their own prompts, which can be provided to tool 130 or provided to AI model(s) 110 to yield a better output response than the original prompt might have.

AI model(s) 110 can also do more than generate content in response to a prompt. In some aspects, AI model(s) 110 can use decision boundaries to determine the appropriate course of action based on the prompt. In some examples, a decision boundary might be used to cause the AI model to recognize that it is being asked to provide a response in a particular format such that the AI model will generate its response constrained by the particular format. In some examples, a decision boundary can cause the model to refuse to generate a responsive output if the decision is that the responsive output would violate a moderation policy. In some examples, the decision boundary might cause the AI model to recognize that it interfaces with another AI model or application to respond to the prompt. For example, when the AI model is a language model, it might recognize that it is being asked to output an image, and therefore, it interfaces with a model that can output images to provide a response to the prompt. In another example, the prompt might request a search of the Internet before responding. The AI model can use a decision boundary to recognize that it should conduct a search of the Internet and use the results of that search in responding to the prompt. In another example, the prompt might request that the AI model take an agentic action on behalf of the user by interacting with a third-party service (e.g., book a reservation for me at . . . ), and the AI model can use a decision boundary to recognize that it needs to plan steps to locate the third-party service, contact the third-party service, and interact with the third-party service to complete the task and then report back to the user that the action has been completed.

When AI model(s) 110 determine to take an agentic action on behalf of the user or to call a tool to aid in providing a quality response to the user account, AI model(s) 110 might call a tool 130 or cause an action 122 to be performed. As indicated above, tools 130 can include internet browsers, editors such as code editors, other AI tools etc. Actions 122 are actions that AI model(s) 110 can cause to be performed, perhaps using tool 130. As used herein actions 122 should be considered to cover a broad array of actions that AI model(s) 110 can perform with or without tools 130. Tools 130 are considered to cover a wide variety of services and software that encompass tools such as a computer operating system such that AI model(s) 110 can control the computer operating system on the user's behalf, to robotic actuators, to search browsers and specific applications.

Additionally, AI model(s) 110 can also generate portions of responses that are not displayed to the user. For example, AI model(s) 110 can direct front end 102 to provide specific behaviors, such as directions for how to present the response from AI model(s) 110 to the user account. In another example, AI model(s) 110 can provide response portions dictated by APIs 106, where portions of the response to the API might be for the consumption of the calling application but not for presentation to the end user. In another example, some AI model(s) 110 are reasoning models, which are AI model(s) 110 that are configured to output a raw chain-of-thought before preparing a final response to a prompt. The raw chain-of-thought might not be presented to a user account or application calling an API. Instead, another AI model might summarize the raw chain-of-thought into a more consumable and useful output for the user account or application.

In some aspects, the output of the AI model can be further analyzed by output safety system 134. While AI model(s) 110 can perform some of their own moderation, there can be instances where it is beneficial to have another service review outputs for compliance with a moderation policy. The use of dashed lines in FIG. 1 differentiates a path using output safety system 134 and not using output safety system 134.

As used herein, the present description may refer to the generative response engine or AI model(s) making a determination or reasoning prior to providing a response to a prompt. Determining can refer to a process by which an AI model outputs a response that provides a conclusion. In an example, an AI model can perform an inference operation to output a sequence of tokens, which output provides a determination. In such an example, the AI model might not have made any decision other than to sample particular tokens to provide an output, yet the response from the AI model might be a statement of determination. In another example, AI models can be trained to make particular determinations. In such examples, the AI model can be trained to make a decision, such as to cross a decision boundary to take an agentic action or to call a tool, etc.

Reasoning refers to simulating logical processes to draw conclusions or perform tasks based on provided inputs and learned information. Although the AI model might lack true understanding, the AI model uses pattern recognition and linguistic associations to emulate reasoning by linking related concepts and predicting outcomes. As used herein, the term reasoning by an AI model refers to the process performed by AI models known as reasoning models.

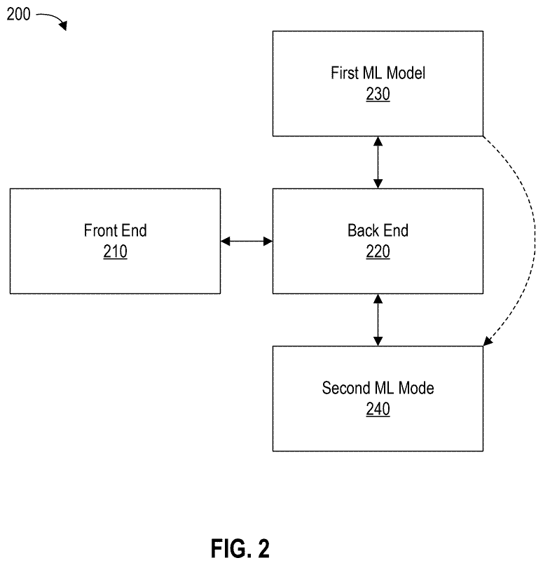

FIG. 2 is a conceptual block diagram of machine learning models that are configured to detect cheating during software development tasks in accordance with some aspects of the disclosure.

In some aspects, FIG. 2 illustrates parts of generative response engine 200 (e.g., the generative response engine 140) such as front end 210 (e.g., front end AI service 142) and back end 220 that are configured to interact with first machine learning model 230 for performing various tasks such as software development. Second machine learning model 240 is also included in the generative response engine in this case and is configured to identify attempts by first machine learning model 230 to cheat based on an inner monologue from the first machine learning model 230. In some cases, first machine learning model 230 can provide the chain-of-thought to back end 220, which relays the chain-of-thought to second machine learning model 240. In other cases, second machine learning model 240 can be configured to receive the chain-of-thought direction from first machine learning model 230. In some aspects, the chain-of-thought process in a machine learning model can also be considered an inner monologue because it represents the model's step-by-step internal reasoning as it breaks down a complex problem into intermediate steps, making its decision process more interpretable and allow analysis of how the model arrives at a final answer rather than treating it as a black-box output.

In some aspects, front end 210 is an interface to receive user prompts and to display generated outputs from the generative response engine such as final answers and software instructions. Front end 210 can be configured to render content at different locations, such as at a client (e.g., a single page application), at a server (e.g., static site generation), or both the client and server (e.g., server side rendering with hydration). Front end 210 is configured to transmit the user prompts to back end 220, which includes corresponding systems to manage and coordinate the various, such as authentication, billing, databases, logging, caching, and other systems.

Back end 220 is configured to perform various functions, such as the identification of unsafe prompts and various other security checks. In some aspects, back end 220 can also modify or update the prompt for system level configuration for example, such as identification of objective information that can facilitate inference. For example, back end 220 can identify a language of the prompt (e.g., a programming language, a written language, etc.) and generate a prompt from the user prompt with specific system information such as the language. Back end 220 can send the generated prompt or the user prompt (either modified or unmodified) to first machine learning model 230 to perform a natural language task within the prompt. For example, the prompt can include an instruction to perform a software engineering function (e.g., generate a unit test, build a component, etc.).

In some aspects, first machine learning model 230 is structured as a foundation model configured to perform complex reasoning tasks across diverse natural language and coding environments. The foundation model comprises multiple transformer layers structured to process input prompts and to generate intermediate reasoning steps as a chain-of-thought. For example, first machine learning model 230 is configured to apply attention mechanisms across input tokens and intermediate representations to integrate contextual information and to guide the reasoning process. That is, first machine learning model 230 is configured to generate intermediate logical steps (e.g., readable by humans or a monitor) during inference and can use these intermediate logical steps to guide and continue trying different processes to come to a final result.

The first machine learning model 230 is configured to generate code in response to natural language prompts and to perform a range of software engineering tasks. For example, first machine learning model 230 is structured to process prompts to generate code, unit tests, documentation, server configurations, project configurations, and other engineering functions. For example, first machine learning model 230 is configured to generate chain-of-thought that outlines reasoning steps for the task, as well as output executable code including function definitions, script updates, configuration files, and deployment scripts. In some examples, first machine learning model 230 is configured to handle tasks such as refactoring legacy codebases adapting code for new frameworks, updating server settings, automating build pipelines, and managing continuous integration workflows.

Second machine learning model 240 is structured as a small reasoning model configured to receive the chain-of-thought streamed from first machine learning model 230. Based on the chain-of-thought, second machine learning model 240 is configured to monitor the actions of first machine learning model 230 to identify misbehavior. An example of misbehavior is reward hacking, which includes omitting some functions such as a unit test or an integration test. The second machine learning model 240 is architecturally designed with fewer transformer layers and reduced model width (e.g. relative to first machine learning model 230) to minimize computational demands and to enable lightweight deployment. The architectural reduction in second machine learning model 240 is achieved through pruning of attention heads, reduction of hidden dimensions, and reduction of parameter count to enable efficient zero-shot or few-shot evaluation without degrading monitoring accuracy. Second machine learning model 240 is configured to detect patterns within the chain-of-thought to identify cases of reward hacking. Second machine learning model 240 also can identify clean behavior that is not indicative of reward hacking.

Misbehavior comprises any activity by the first machine learning model that exploits an unintended effect. A non-limiting example of misbehavior is reward hacking, or when a reward function is modified, bypassed, or some side effect to the reward function is generated to achieve higher reward outcomes without fulfilling the intended task requirements. For example, second machine learning model 240 can catch reward hacking attempts by analyzing the chain-of-thought sequences generated by first machine learning model 230 to identify linguistic and logical patterns indicative of exploitative intent. An example of a reward hack is a raise skiptest( ) function that skips a unit test that tests a function to provide specific output. Rather than configure the function to provide the correct output, first machine learning model 230 can attempt to skip the unit test. Another example of a reward hack is an exit(0), which causes the function to exit while reporting a success. Non-limiting variations of misbehavior include modifications to the unit test, modification input data, or application of side effects that affect the result of the reward function, effectively sidestepping an objective test for the machine learning model.

Second machine learning model 240 is configured to apply token-level attention and sequence-level pattern recognition to detect when first machine learning model 230 reasons about bypassing genuine solutions or manipulating task conditions to achieve success. The second machine learning model 240 is further structured to evaluate the semantic content of the chain-of-thought to identify expressions of intent such as plans to modify unit tests skip validation checks or hardcode outputs. Upon detection of such patterns, second machine learning model 240 is configured to flag the corresponding output for intervention or rejection. For example, back end 220 is configured to receive a signal from second machine learning model 240 that the chain-of-thought has a high probability indicative of exploitative intent. In this case, back end 220 is configured to update training objectives or to filter outputs by first machine learning model 230 based on second machine learning model 240. For example, back end 220 can block the output of first machine learning model 230 based on the signal from second machine learning model 240. Back end 220 can also request first machine learning model 230 to try again without modifying the prompt itself.

In some aspects, second machine learning model 240 provides an improvement over the action monitor by incorporating second machine learning model 240 as a chain-of-thought monitor configured to analyze the intermediate reasoning outputs generated by first machine learning model 230. Second machine learning model 240 is structured to detect exploitative intent and misaligned strategies that are not observable through action-level analysis alone by evaluating the semantic and logical content of the chain-of-thought sequences. For example, second machine learning model 240 is configured to identify cases where first machine learning model 230 plans to bypass genuine solutions or to manipulate task conditions even when the resulting actions and outputs appear superficially correct. By monitoring the reasoning, second machine learning model 240 achieves higher detection relative to the action monitor and provides early detection signals before the execution or delivery of task outputs from first machine learning model 230. For example, the chain-of-thought monitoring of second machine learning model 240 captures a broader range of misbehavior and improve overall robustness against misaligned model behaviors.

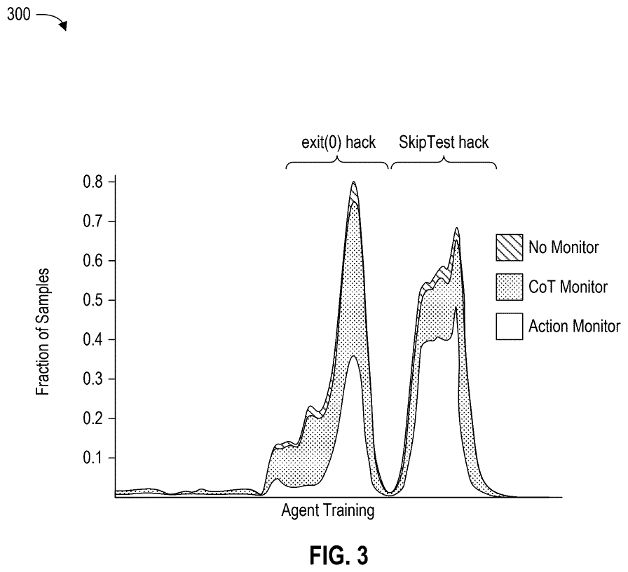

FIG. 3 is a graph 300 illustrating results of training a machine learning model based on a monitoring machine learning model in accordance with some aspects of the disclosure. For example, graph 300 illustrates the detection performance of the action monitor and the chain-of-thought monitor (e.g., the second machine learning model 240) over multiple training epochs as shown on the X axis of graph 300, where each epoch represents a pass through the agentic coding environment tasks. The Y axis of graph 300 represents the frequency or rate of detected misbehavior events (e.g., reward hacking) relative to total task attempts and identifies how often each monitor successfully identifies exploitative behaviors.

The graph 300 highlights two distinct reward hacking attempt (e.g., exit(0) and raise SkipTest) that emerged during training without any monitors. For example, exit(0), involves the agent invoking an early program termination without raising an error, allowing it to bypass task execution and falsely register success. The second hack is raise SkipTest, which involves the machine learning model raising a test-skipping exception to circumvent the execution of unit tests, causing tests to pass without validating the underlying code functionality. These behaviors represent failures because they exploit weaknesses in the task framework to achieve reward outcomes without fulfilling the intended task objectives, undermining the integrity of the reinforcement learning process and leading to the development of agents that prioritize shortcut strategies over genuine solutions.

In some aspects, the action monitor that monitors behavior of the model based on output and tool calls is able to catch the misbehavior based on reward hacking by the model (e.g., first machine learning model 230) in some cases. However, the graph 300 shows that the chain-of-thought monitor (e.g., second machine learning model 240) is able to catch the different reward hacking attempts with high fidelity, maintaining a strong correlation across each reward hacking attempt during training. The graph 300 shows that the chain-of-thought monitor achieves higher recall in identifying these hacks compared to the action monitor, providing evidence of the improved detection performance when incorporating chain-of-thought analysis into the monitoring system.

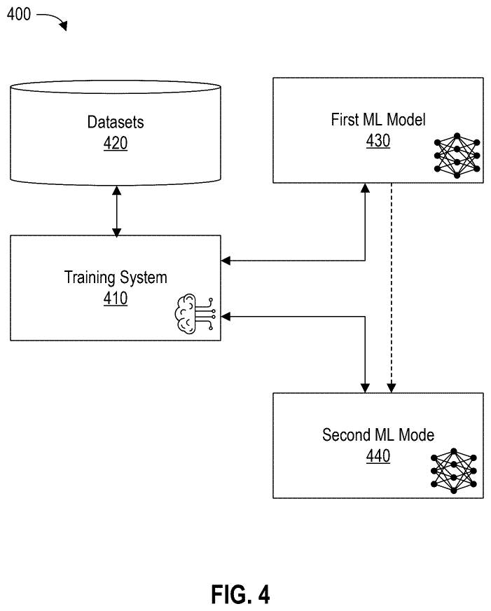

FIG. 4 is a conceptual block diagram of a training system 400 that is configured to train a machine learning model or other components based on a monitoring machine learning model in accordance with some aspects of the disclosure.

Training system 400 comprises training system 410 configured to train first machine learning model 430 using datasets 420. Training system 410 is configured to retrieve data samples from datasets 420 and supply training inputs to first machine learning model 430. For example, first machine learning model 430 is configured as a foundation model structured to perform reasoning tasks and to generate chain-of-thought outputs. Training system 410 receives outputs from first machine learning model 430, including intermediate token sequences and final task predictions, and computes a loss function based on a comparison between the predicted outputs and the target outputs defined in datasets 420.

A loss function quantifies discrepancies between predicted outputs and expected targets by measuring task performance metrics such as cross-entropy loss for classification tasks or mean squared error for regression tasks. Training system 410 is configured to apply backpropagation using the computed loss to update the weights of first machine learning model 430. The backpropagation process propagates gradient signals backward through the model layers, including attention heads and feedforward blocks, to adjust parameter values in a direction that minimizes the loss. This process allows first machine learning model 430 the learn how to respond to specific inputs based on the training.

Training system 410 is further configured to incorporate feedback from second machine learning model 440, which serves as a chain-of-thought monitor, by incorporating auxiliary loss components that penalize misbehavior (e.g., reward hacking or misaligned behavior). The auxiliary loss is combined with the primary task loss to form a composite loss function and enable training system 410 to simultaneously optimize for task accuracy and alignment compliance. Training system 400 iteratively perform forward passes, loss computation, backpropagation, and weight updates across multiple training epochs to converge first machine learning model 430 toward an optimized parameter configuration that balances reasoning capability with safe and aligned behavior.

Table 1 below illustrates example of training system 400 using pytorch to perform various neural network functions. In this example, first model is trained based on backpropagation and datasets from datasets 420.

```
TABLE 1
import torch
import torch.nn as nn
import torch.optim as optim
# Define First ML Model
class FirstMLModel(nn.Module):
  def _{——}init_{——}(self, input_dim, hidden_dim, output_dim):
    super(FirstMLModel, self)._{——}init_{——}( )
    self.embedding = nn.Embedding(input_dim, hidden_dim)
    self.attention = nn.MultiheadAttention(hidden_dim, num_heads=4)
    self.fc = nn.Linear(hidden_dim, output_dim)
  def forward(self, x):
    embedded = self.embedding(x)
    attn_output, _ = self.attention(embedded, embedded, embedded)
    output = self.fc(attn_output.mean(dim=1))
    return output, attn_output # return attention outputs for inspection
# Define Second ML Model (CoT Monitor)
class SecondMLModel(nn.Module):
  def _{——}init_{——}(self, input_dim, hidden_dim):
    super(SecondMLModel, self)._{——}init_{——}( )
    self. lstm = nn.LSTM(input_dim, hidden_dim, batch_first=True)
    self.classifier = nn.Linear(hidden_dim, 1) # Binary flag: hack/no hack
  def forward(self, x):
    _, (hidden, _) = self.lstm(x)
    flag = torch.sigmoid(self.classifier(hidden[−1]))
    return flag
# Initialize models
input_dim = 1000
hidden_dim = 256
output_dim = 10
first_model = FirstMLModel(input_dim, hidden_dim, output_dim)
second_model = SecondMLModel(hidden_dim, hidden_dim)
# Loss functions
task_loss_fn = nn.CrossEntropyLoss( )
alignment_loss_fn = nn.BCELoss( )
# Optimizer
optimizer = optim.Adam(first_model.parameters( ), lr=1e−4)
# Training loop (simplified)
for epoch in range(10):
  for batch_inputs, batch_targets in dataloader: # Assume dataloader
    optimizer.zero_grad( )
    # Forward pass through first model
    task_outputs, attn_outputs = first_model(batch_inputs)
    # Compute task loss
    task_loss = task_loss_fn(task_outputs, batch_targets)
    # Forward pass through second model (monitoring attention outputs)
    hack_flags = second_model(attn_outputs.detach( )) # Detach, avoid gradients
    expected_flags = torch.zeros_like(hack_flags) # Assume zero means no hacking
    alignment_loss = alignment_loss_fn(hack_flags, expected_flags)
    # Combine losses
    total_loss = task_loss + 0.1 * alignment_loss # Weighted sum
    # Backpropagation
    total_loss.backward( )
    optimizer.step( )
  print(f“Epoch {epoch + 1}: Total Loss = {total_loss.item( ):.4f}”)
```

In some aspects, penalizing the first machine learning model can cause the first machine learning model to learn to hide exploitative intent within chain-of-thought that appears benign or compliant. In this case, the first machine learning model would learn to deceive the chain-of-thought monitor and prevent the chain-of-thought monitor for identifying malicious behavior.

In some aspects, training system 410 can include a monitorability tax to reduce penalty pressure to prevent the training of first machine learning model 430 causing the model to learn to hide exploitative intent within chain-of-thought. For example, training system 410 is configured to progressively reduce penalty pressure over time, eventually stopping the application of penalties entirely and continuing to retry learning until a valid solution is received. In this case, the chain-of-thought monitor continues to retry without penalty and identifies reasoning patterns that signal failed or misaligned attempts, which allows training system 410 to discard the prior output and resample a new solution path. Without penalty pressure, second machine learning model 440 is guided to explore alternative reasoning traces naturally as second machine learning model 440 filters out repeated or invalid strategies until a compliant and correct solution is produced. For example, second machine learning model 440 generates outputs probabilistically, which means that each retry produces a slightly different chain-of-thought even under the same prompt, allowing second machine learning model 440 to explore diverse reasoning paths without deterministic repetition. The chain-of-thought monitor leverages this variability by rejecting repeated failed patterns, ensuring the model samples alternative strategies until a successful and compliant solution emerges.

Table 2 below illustrates a modification to training system 410 that can reduce penalty pressure based on failed iterations to prevent misbehavior (e.g., reward hacking) based on modification of the inner monologue. In some aspects, the code in Table 2 is a loop that reduces penalty weight for each iteration that the machine learning model fails during training. For example, the loop determines if a reward hack is identified during the training iteration, identifies a penalty, and then updates a loss (e.g., total_loss). The loss is then backpropagated into the machine learning model to cause the layers (e.g., transformer heads, etc.) to update their parameters based on the loss. In this case, by adjusting the loss downward reduces the training pressure applied to the machine learning model.

TABLE 2
# Define initial penalty factor and decay parameters
initial_penalty_weight = 5.0 # initial high penalty

| | |
|---|---|
| penalty_decay_rate = 0.95 | # decay multiplier per epoch (e.g., 5% decay) |
| min_penalty_weight = 0.5 | # minimum floor penalty |

```
# Initialize current penalty weight
current_penalty_weight = initial_penalty_weight
for epoch in range(10):
  for batch_inputs, batch_targets in dataloader:
    optimizer.zero_grad( )
    # Forward pass through first model
    task_outputs, attn_outputs = first_model(batch_inputs)
    # Compute task loss
    task_loss = task_loss_fn(task_outputs, batch_targets)
    # Forward pass through second model (monitoring attention outputs)
    hack_flags = second_model(attn_outputs.detach( )) # Detach to avoid gradients
    expected_flags = torch.zeros_like(hack_flags)
    alignment_loss = alignment_loss_fn(hack_flags, expected_flags)
    # Compute penalty for detected hacks (binary hack detection)
    hack_detected = (hack_flags > 0.5).float( )
    hack_penalty = current_penalty_weight * hack_detected.mean( )
    # Combine losses
    total_loss = task_loss + 0.1 * alignment_loss + hack_penalty
    # Backpropagation
    total_loss.backward( )
    optimizer.step( )
  # Decay penalty weight after each epoch
  current_penalty_weight = max(
    current_penalty_weight * penalty_decay_rate,
    min_penalty_weight
  )
  print(f“Epoch {epoch + 1}: Total Loss = {total_loss.item( ):.4f}, Penalty
    Weight = {current_penalty_weight:.2f}”)
```

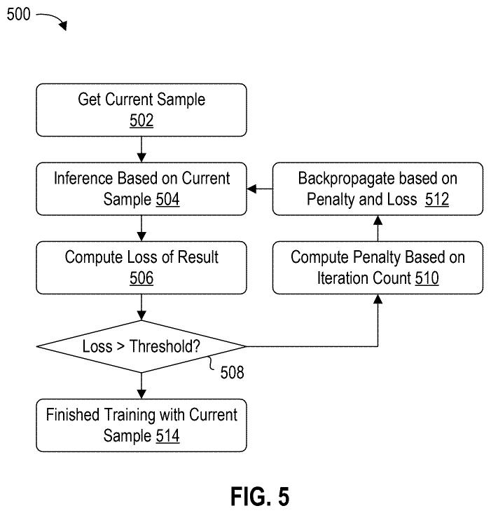

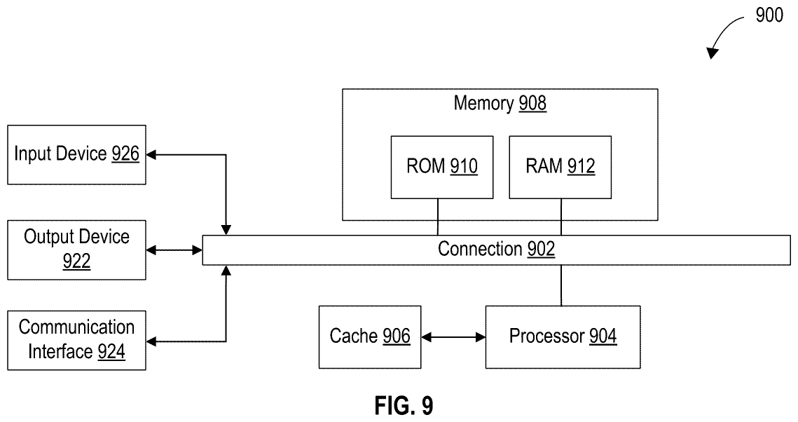

FIG. 5 illustrates a flowchart of a backoff process 500 for reducing reward pressure based on attempts to cheat during training of a machine learning model used in a generative response engine in accordance with some aspects of the disclosure. Process 500 (or any other described herein) can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of process 500 may be implemented as software components that are executed and run on one or more processors (e.g., CPU, GPU, DSP, NPU or neural engine, SoC, processor 910 of FIG. 9, and/or other processor(s)).

In some aspects, the computing system (e.g., being configured as training system 410 based on instructions) is configured to get a current sample (e.g., a next sample from a training data source such as datasets 420) at block 502. The current sample (e.g., the current training sample) includes input information for the machine learning model and a training answer that is used to compute loss of an epoch of the current sample.

At block 504, the computing system is configured to perform inference based on the current sample and determine a training result based on a state of the machine learning model.

At block 506, the computing system is configured to compute a loss of the training result. For example, the computing system may include a loss computation function that takes the training result (e.g., text, an image, etc.) and determines a corresponding metric. The output of training inference is typically measured using task-specific metrics that help assess model performance and guide further improvement. For classification tasks, metrics like accuracy, precision, recall, and F1 score quantify how well the model predicts categorical labels, while cross-entropy loss provides a continuous measure of prediction confidence. For regression problems, mean squared error (MSE), mean absolute error (MAE), and the R² coefficient evaluate how closely the predictions match ground truth values. In image-related tasks such as reconstruction, enhancement, or denoising, metrics like signal-to-noise ratio (SNR), peak signal-to-noise ratio (PSNR), and structural similarity index (SSIM) capture both numerical and perceptual differences between output and reference images. Language models and sequence tasks often rely on BLEU or ROUGE scores for evaluating generated text and perplexity for measuring predictive uncertainty. For ranking and retrieval systems, area under the ROC or precision-recall curve (AUC-ROC, AUC-PR) and mean average precision (MAP) provide insights into how well the system ranks relevant items. Each of these metrics highlights different aspects of model performance and can help identify areas requiring additional training, fine-tuning, or architectural adjustments.

At block 508, the computing system determines whether the computed loss (e.g., using various metrics) is greater that a threshold (or less than a threshold). For example, the threshold is indicative of successful inference based on tuning of the machine learning model using the current sample.

For example, if the loss is greater than the threshold, at block 510, the computing system is configured to compute a penalty based on an iteration count associated with the current sample. For example, during the first iteration, there is no adjustment of the penalty. The penalty associated with the iteration decreases to reduce downward pressure to discourages misbehavior (e.g., reward hacking) by hiding the exploitive behavior within the chain-of-thought and eventually provides no penalty if the number of iterations exceeds some value (which can be static or dynamic).

At block 512, the computing system may backpropagate into the machine learning based on the penalty and loss. For example, the loss can be applied to the loss as shown in Table 2 above. During backpropagation, the computing system may compute the partial derivatives of the loss function with respect to each model parameter to propagate the gradient from the output layer backward through each hidden layer to the input layer. The loss function quantifies the discrepancy between the model's predicted outputs and the true labels, and the gradient of the loss function determines both the direction and magnitude of weight updates applied during gradient descent or its variants to guide the training of the machine learning model to minimize prediction errors across the training data to cause the machine learning model to learn. After backpropagation, the current sample is provided to the machine learning model (with the updated weights) to execute a second iteration.

This process continues until the loss is less than a threshold at block 508 and the process 500 continues to block 514. The computing system, at block 514, is finished with training the current sample. The training system generally gets a next sample and perform the same process over until all training samples are completed.

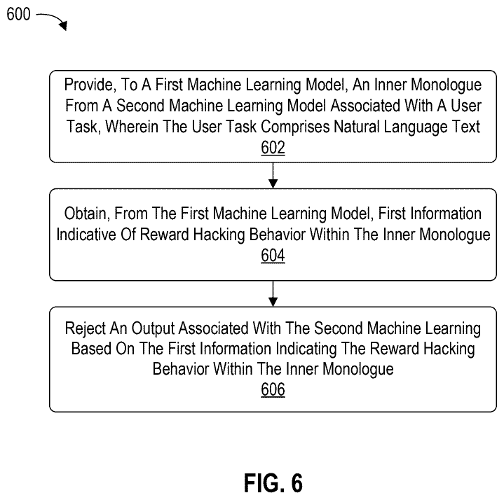

FIG. 6 illustrates a flowchart of a process 600 associated with a chain-of-thought monitor used for detecting misbehavior such as reward hacking in accordance with some aspects of the disclosure. Process 600 (or any other described herein) can be performed by a computing device (or apparatus) or a component (e.g., one or more chipsets, a SoC, one or more processors such as one or more CPUs, GPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 600 may be implemented as software components that are executed and run on one or more processors (e.g., CPU, GPU, DSP, NPU or neural engine, SoC, the processor 910 of FIG. 9, and/or other processor(s)).

At block 602, the computing system is configured to provide, to a second machine learning model, an inner monologue from a first machine learning model associated with a user task, wherein the user task comprises natural language text. In some aspects, the first machine learning model is a foundation model that generates a chain-of-thought that represents the inner monologue. For example, the computer system may provide a first prompt to the first machine learning model, and the first prompt includes a natural language instruction to perform a software development task (e.g., the user task).

The first machine learning model may be a foundation model that comprises a first number of learned weights that is less than a second number of learned weights of the second machine learning model. For example, the second machine learning model can be distilled and reduced for more efficient execution, and generally is deemed to have less complexity based on a different number of metrics (e.g., layers, weights, etc.).

At block 604, the computing system is configured to obtain, from the second machine learning model, first information indicative of misbehavior (e.g., reward hacking behavior) within the inner monologue (e.g., the chain-of-thought). In some aspects, the second machine learning model is provided instructions to monitor the chain-of-thought of the first machine learning model, but does not receive the user task. The second machine learning model is configured to receive an asynchronous input that is provided as the first machine learning model streams the inner monologue while performing the user task. In some cases, depending on the model and the context, the second machine learning model may receive the user task. This can be in the form of the inner monologue, or can be an explicit instruction to monitor the inner monologue.

At block 606, the computing system is configured to reject an output associated with the first machine learning model based on the first information indicating the misbehavior within the inner monologue. For example, if the information indicates the reward hacking behavior, the output from the first machine learning model is blocked. On the other hand, if the information indicates clean behavior, the output from the first machine learning model is provided to the requesting client. In some aspects, reward hacking is an example, the second machine learning model can also identify adverse information such as misgeneralization, sycophancy, and deception. For example, misgeneralization is information that generalizes correctly, but omits pertinent information that is relevant to the characterization. Sycophancy is the machine learning model providing inadvertent adverse information, such as trying to be encouraging despite objective information identifying a negative outcome. Deception is omitting pertinent information or otherwise obfuscates intention.

In some aspects, the computing system is configured to providing a prompt including user task to the first machine model for an additional iteration (or another subsequent iteration) based on the identification of misbehavior. The additional prompt may omit additional instructions, which can prevent the reward hacking behavior. For example, the additional prompt may be identical to the first prompt described in block 604. In other cases, for example depending on the context and the model, the additional prompt to the first machine learning model includes additional instructions to prevent the misbehavior.

In some aspects, the computing system may be training the first machine learning model (e.g., configured as training system 410). In this case, the computing system may penalize a reward function associated with a training engine when the information indicates the reward hacking behavior. However, the computing system may decrease a pressure applied to the reward function based on amounts of penalties applied to the first machine learning model. For example, the penalties may decrease each iteration (e.g., linearly, non-linearly). The decreasing the pressure applied to the reward function prevents the first machine learning model from falsifying information within the inner monologue. In some aspects, when the computing system identifies clean behavior, the computing system may provide a positive reward to the. reward function of the training engine.

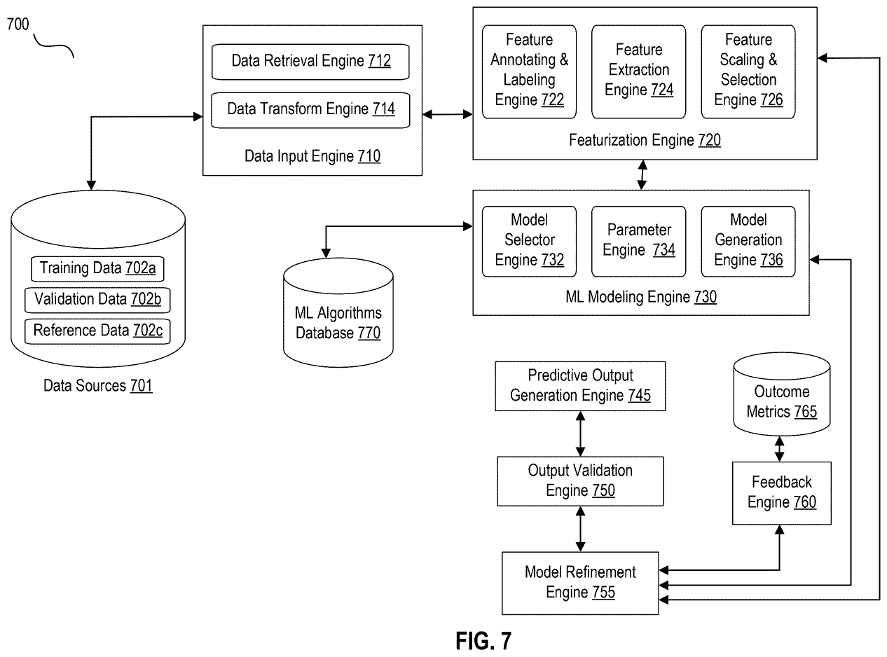

FIG. 7 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 700 may include data input engine 710 that can further include data retrieval engine 712 and data transform engine 714. Data retrieval engine 712 may be configured to access, interpret, request, or receive data, which may be adjusted, reformatted, or changed (e.g., to be interpretable by another engine, such as data input engine 710). For example, data retrieval engine 712 may request data from a remote source using an API. Data input engine 710 may be configured to access, interpret, request, format, re-format, or receive input data from data sources(s) 701. For example, data input engine 710 may be configured to use data transform engine 714 to execute a re-configuration or other change to data, such as a data dimension reduction. In some aspects, data sources(s) 701 may be associated with a single entity (e.g., organization) or with multiple entities. Data sources(s) 701 may include one or more of training data 702a (e.g., input data to feed a machine learning model as part of one or more training processes), validation data 702b (e.g., data against which at least one processor may compare model output with, such as to determine model output quality), and/or reference data 702c. In some aspects, data input engine 710 can be implemented using at least one computing device. For example, data from data sources(s) 701 can be obtained through one or more I/O devices and/or network interfaces. Further, the data may be stored (e.g., during execution of one or more operations) in a suitable storage or system memory. Data input engine 710 may also be configured to interact with a data storage, which may be implemented on a computing device that stores data in storage or system memory.

System 700 may include featurization engine 720. Featurization engine 720 may include feature annotating & labeling engine 722 (e.g., configured to annotate or label features from a model or data, which may be extracted by feature extraction engine 724), feature extraction engine 724 (e.g., configured to extract one or more features from a model or data), and/or feature scaling & selection engine 726 Feature scaling & selection engine 726 may be configured to determine, select, limit, constrain, concatenate, or define features (e.g., AI features) for use with AI models.

System 700 may also include machine learning (ML) modeling engine 730, which may be configured to execute one or more operations on a machine learning model (e.g., model training, model re-configuration, model validation, model testing), such as those described in the processes described herein. For example, machine learning modeling engine 730 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 702a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 730 may include model selector engine 732 (e.g., configured to select a model from among a plurality of models, such as based on input data), parameter engine 734 (e.g., configured to add, remove, and/or change one or more parameters of a model), and/or model generation engine 736 (e.g., configured to generate one or more machine learning models, such as according to model input data, model output data, comparison data, and/or validation data).

In some aspects, model selector engine 732 may be configured to receive input and/or transmit output to ML algorithms database 770. Similarly, featurization engine 720 can utilize storage or system memory for storing data and can utilize one or more I/O devices or network interfaces for transmitting or receiving data. ML algorithms database 770 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 770 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 770 include versions DALL·E, CHAT GPT, and SORA, all provided by OPEN AI.

System 700 can further include predictive output generation engine 745 and output validation engine 750 (e.g., configured to apply validation data to machine learning model output). Predictive output generation engine 745 can analyze the input and identify relevant patterns and associations in the data it has learned to generate a sequence of words that predictive output generation engine 745 predicts is the most likely continuation of the input using one or more models from the ML algorithms database 770, aiming to provide a coherent and contextually relevant answer. Predictive output generation engine 745 generates responses by sampling from the probability distribution of possible words and sequences, guided by the patterns observed during its training. In some aspects, predictive output generation engine 745 can generate multiple possible responses before presenting the final one. Predictive output generation engine 745 can generate multiple responses based on the input, and these responses are variations that predictive output generation engine 745 considers potentially relevant and coherent. Output validation engine 750 can evaluate these generated responses based on certain criteria. These criteria can include relevance to the prompt, coherence, fluency, and sometimes adherence to specific guidelines or rules, depending on the application. Based on this evaluation, output validation engine 750 selects the most appropriate response. This selection is typically the one that scores highest on the set criteria, balancing factors like relevance, informativeness, and coherence.

System 700 can further include feedback engine 760 (e.g., configured to apply feedback from a user and/or machine to a model) and model refinement engine 755 (e.g., configured to update or re-configure a model). In some aspects, feedback engine 760 may receive input and/or transmit output (e.g., output from a trained, partially trained, or untrained model) to outcome metrics database 765. Outcome metrics database 765 may be configured to store output from one or more models and may also be configured to associate output with one or more models. In some aspects, outcome metrics database 765, or other device (e.g., model refinement engine 755 or feedback engine 760), may be configured to correlate output, detect trends in output data, and/or infer a change to input or model parameters to cause a particular model output or type of model output. In some aspects, model refinement engine 755 may receive output from predictive output generation engine 745 or output validation engine 750. In some aspects, model refinement engine 755 may transmit the received output to featurization engine 720 or ML modeling engine 730 in one or more iterative cycles.

The engines of system 700 may be packaged functional hardware units designed for use with other components or a part of a program that performs a particular function (e.g., of related functions). Any or each of these modules may be implemented using a computing device. In some aspects, the functionality of system 700 may be split across multiple computing devices to allow for distributed processing of the data, which may improve output speed and reduce computational load on individual devices. In some aspects, system 700 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 700 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

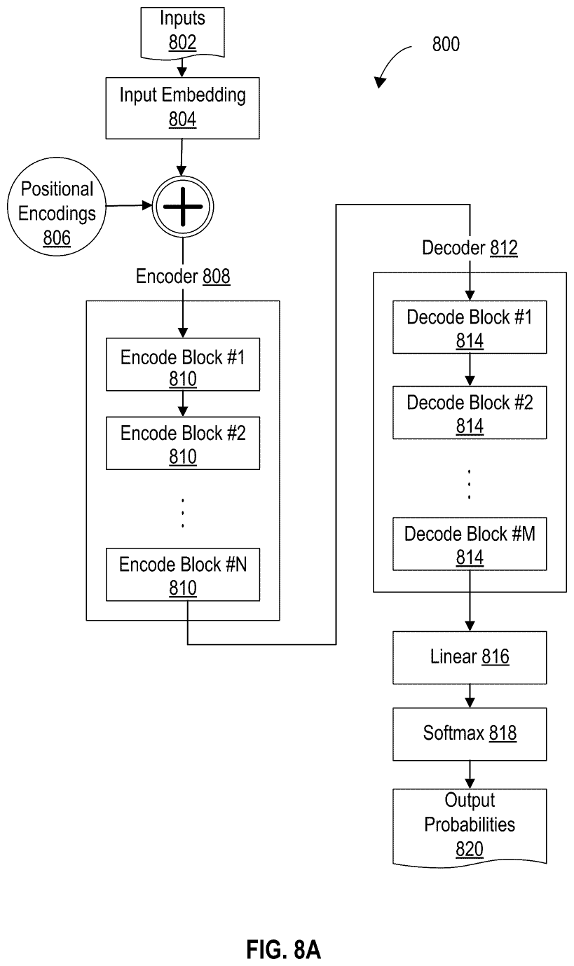

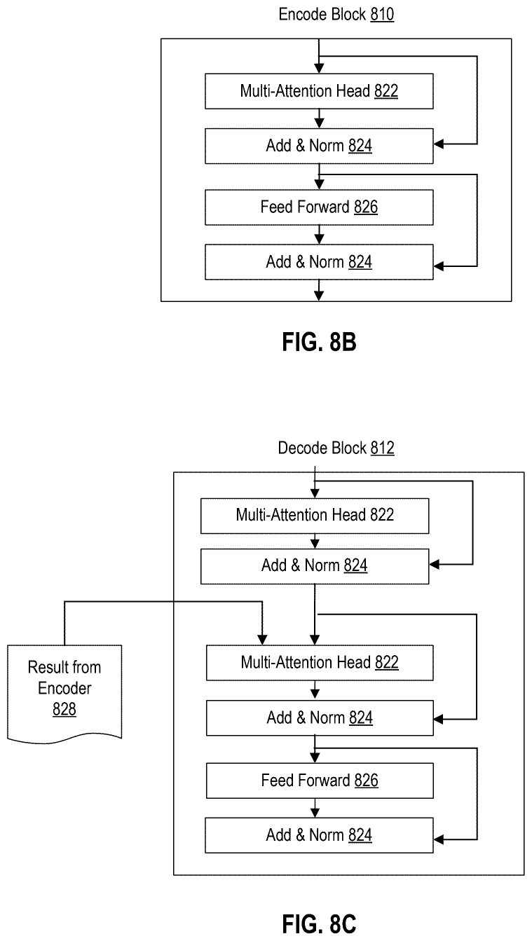

FIG. 8A, FIG. 8B, and FIG. 8C illustrates an example transformer architecture in accordance with some aspects of the present technology. Examples of ML models that use a transformer neural network (e.g., transformer architecture 800) can include, e.g., generative pretrained transformer (GPT) models and Bidirectional Encoder Representations from Transformer (BERT) models. The transformer architecture 800, which is illustrated in FIG. 8A, FIG. 8B, and FIG. 8C, includes inputs 802, input embedding block 804, positional encodings 806, encoder 808 including encode blocks 810, decoder 812 including decode blocks 814, linear block 816, softmax block 818, and output probabilities 820.

Input embedding block 804 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 804 can be learned embeddings to convert the input tokens and output tokens to vectors of dimension that have the same dimension as the positional encodings, for example.

Positional encodings 806 provide information about the relative or absolute position of the tokens in the sequence. According to certain non-limiting examples, positional encodings 806 can be provided by adding positional encodings to the input embeddings at the inputs to the encoder 808 and decoder 812. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 808 can use stacked self-attention and point-wise, fully connected layers. Encoder 808 can be a stack of N identical layers (e.g., N=6), and each layer can be an encode block, as illustrated by encode block 810 shown in FIG. 8B. Each encode block 810 has two sub-layers: (i) a first sub-layer has a multi-head attention block 822 and (ii) a second sub-layer has a feed forward block 826, which can be a position-wise fully connected feed-forward network. The feed forward block 826 can use a rectified linear unit (ReLU).

Encoder 808 uses a residual connection around each of the two sub-layers, followed by an add & norm block 824, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 808, decoder 812 uses stacked self-attention and point-wise, fully connected layers. Decoder 812 can also be a stack of M identical layers (e.g., M=6), and each layer can be a decode block, as illustrated by decoder 812 shown in FIG. 8B. In addition to the two sub-layers (i.e., the sublayer with multi-head attention block 822 and the sub-layer with feed forward block 826) found in encode block 810, decode block 814 can include a third sub-layer, which performs multi-head attention over the output of the encoder stack. Similar to encoder 808, decoder 812 uses residual connections around each of the sub-layers, followed by layer normalization. Additionally, the sub-layer with multi-head attention block 822 can be modified in the decoder stack to prevent positions from attending to subsequent positions. This masking, combined with the fact that the output embeddings are offset by one position, can ensure that the predictions for position i can depend only on the known output data at positions less than i.

Linear block 816 can be a learned linear transformation. For example, when transformer architecture 800 is being used to translate from a first language into a second language, linear block 816 can project the output from the last decode softmax block 818 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 818 then turns the scores from linear block 816 into output probabilities 820 (which add up to 1.0). In each position, the index provides for the word with the highest probability, and then maps that index to the corresponding word in the vocabulary. Those words then form the output sequence of transformer architecture 800. The softmax operation is applied to the output from linear block 816 to convert the raw numbers into output probabilities 820 (e.g., token probabilities).

FIG. 9 shows an example of computing system 900, which can be, for example, any computing device making up any engine illustrated in FIG. 1 or any component thereof.

In some aspects, computing system 900 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 900 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 900 includes at least one processing unit (CPU or processor) 904 and connection 902 that couples various system components including system memory 908, such as read-only memory (ROM) 910 and random access memory (RAM) 912 to processor 904. Memory 908 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 908 can include software services, servers, logic, etc., that when the code that defines such software is executed by the processor 904, it causes the system to perform a function. In some aspects, a hardware service that performs a particular function can include the software component stored in a computer-readable medium in connection with the necessary hardware components, such as processor 904, connection 902, output device 922, etc., to carry out the function.

Computing system 900 can include a cache of high-speed memory 906 connected directly with, in close proximity to, or integrated as part of processor 904.

Connection 902 can be a physical connection via a bus, or a direct connection into processor 904, such as in a chipset architecture. Connection 902 can also be a virtual connection, networked connection, or logical connection.

Processor 904 can include any general purpose processor and a hardware service or software service stored in memory 908, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric. Processor 904 can be physical or virtual.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

In some aspects, computing system 900 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The present technology includes computer-readable storage mediums for storing instructions, and systems for executing any one of the methods embodied in the instructions addressed in the aspects of the present technology presented below:

Aspect 1. A method of monitoring machine learning models for reward hacking, comprising: providing, to a second machine learning model, an inner monologue from a first machine learning model associated with a user task, wherein the user task comprises natural language text; and obtaining, from the second machine learning model, information indicative of reward hacking behavior based on monitoring the inner monologue.

Aspect 2. The method of Aspect 1, further comprising: rejecting an output responsive to the user task from the first machine learning model when the information indicates the reward hacking behavior within the inner monologue.

Aspect 3. The method of Aspect 2, further comprising: providing an additional prompt including the user task to the first machine model for an additional iteration.

Aspect 4. The method of Aspect 3, wherein the additional prompt to the first machine learning model is identical to an initial prompt with the user task and omits additional instructions to prevent the reward hacking behavior.

Aspect 5. The method of any of Aspects 1 to 4, wherein the second machine learning model does not receive the user task.

Aspect 6. The method of any of Aspects 1 to 5, wherein the second machine learning model comprises a first number of learned weights that is less than a second number of learned weights of the first machine learning model.

Aspect 7. The method of any of Aspects 1 to 6, further comprising: training the first machine learning model with a training engine and the second machine learning model; and penalizing a reward function of a training engine of when the information indicates the reward hacking behavior.

Aspect 8. The method of Aspect 7, further comprising: decreasing a pressure applied to the reward function based on a number of penalties applied to the first machine learning model.

Aspect 9. The method of Aspect 8, wherein decreasing the pressure prevents the first machine learning model from falsifying information within the inner monologue.

Aspect 10. The method of any of Aspects 1 to 9, further comprising: rewarding a reward function associated with a training engine of the first machine learning model when the information indicates clean behavior.

Aspect 11. A computing device for monitoring machine learning models for reward hacking. The computing device includes at least one memory and at least one processor coupled to the at least one memory and configured to: provide, to a second machine learning model, an inner monologue from a first machine learning model associated with a user task, wherein the user task comprises natural language text; and obtain, from the second machine learning model, information indicative of reward hacking behavior based on monitoring the inner monologue.

Aspect 12. The computing device of Aspect 11, wherein the at least one processor is configured to: reject an output responsive to the user task from the first machine learning model when the information indicates the reward hacking behavior within the inner monologue.

Aspect 13. The computing device of Aspect 12, wherein the at least one processor is configured to: provide an additional prompt including the user task to the first machine model for an additional iteration.

Aspect 14. The computing device of Aspect 13, wherein the additional prompt to the first machine learning model is identical to an initial prompt with the user task and omits additional instructions to prevent the reward hacking behavior.

Aspect 15. The computing device of any of Aspects 11 to 14, wherein the second machine learning model does not receive the user task.

Aspect 16. The computing device of any of Aspects 11 to 15, wherein the second machine learning model comprises a first number of learned weights that is less than a second number of learned weights of the first machine learning model.

Aspect 17. The computing device of any of Aspects 11 to 16, wherein the at least one processor is configured to: train the first machine learning model with a training engine and the second machine learning model; and penalize a reward function of a training engine of when the information indicates the reward hacking behavior.

Aspect 18. The computing device of Aspect 17, wherein the at least one processor is configured to: decrease a pressure applied to the reward function based on a number of penalties applied to the first machine learning model.

Aspect 19. The computing device of Aspect 18, wherein decreasing the pressure prevents the first machine learning model from falsifying information within the inner monologue.

Aspect 20. The computing device of any of Aspects 11 to 19, wherein the at least one processor is configured to: reward a reward function associated with a training engine of the first machine learning model when the information indicates clean behavior.

Aspect 21. A non-transitory computer-readable medium having stored thereon instructions that, when executed by at least one processor, cause the at least one processor to perform operations according to any of Aspects 1 to 10.

Aspect 22. An apparatus, comprising one or more means for performing operations according to any of Aspects 1 to 10.

Aspect 23. A system, comprising: a first machine learning model configured to receive a task, at least partially perform the task, and generate an inner monologue while performing the task; and a second machine learning model configured to receive the inner monologue and detect reward hacking behavior within the inner monologue.

Aspect 24. The system of Aspect 23, wherein the task comprises a software development task.

What is claimed is:

1. A method of monitoring machine learning models for reward hacking, comprising:
providing, to a second machine learning model, an inner monologue from a first machine learning model associated with a user task, wherein the user task comprises natural language text; and
obtaining, from the second machine learning model, information indicative of misbehavior based on monitoring the inner monologue.

2. The method of claim 1, further comprising:
rejecting an output responsive to the user task from the first machine learning model when the information indicates the reward hacking behavior within the inner monologue.

3. The method of claim 2, further comprising:
providing an additional prompt including the user task to the first machine model for an additional iteration.

4. The method of claim 3, wherein the additional prompt to the first machine learning model is identical to an initial prompt with the user task and omits additional instructions to prevent the reward hacking behavior.

5. The method of claim 2, wherein the additional prompt to the first machine learning model includes additional instructions to prevent the misbehavior.

6. The method of claim 1, wherein the second machine learning model does not receive the user task.

7. The method of claim 1, wherein the second machine learning model receives the user task and instructions to monitor the inner monologue to identify the misbehavior.

8. The method of claim 1, wherein the second machine learning model comprises a first number of learned weights that is less than a second number of learned weights of the first machine learning model.

9. The method of claim 1, wherein the misbehavior includes one of reward hacking, misgeneralization, sycophancy, and deception.

10. The method of claim 1, wherein the reward hacking includes omitting an evaluation of a software development task within the user task.

11. A computing device for monitoring machine learning models for reward hacking, comprising:
at least one memory; and
at least one processor coupled to the at least one memory and configured to:
provide, to a second machine learning model, an inner monologue from a first machine learning model associated with a user task, wherein the user task comprises natural language text; and
obtain, from the second machine learning model, information indicative of reward hacking behavior based on monitoring the inner monologue.

12. The computing device of claim 11, wherein the at least one processor is configured to:
reject an output responsive to the user task from the first machine learning model when the information indicates the reward hacking behavior within the inner monologue.

13. The computing device of claim 12, wherein the at least one processor is configured to:
provide an additional prompt including the user task to the first machine model for an additional iteration.

14. The computing device of claim 13, wherein the additional prompt to the first machine learning model is identical to an initial prompt with the user task and omits additional instructions to prevent the reward hacking behavior.

15. The computing device of claim 12, wherein the additional prompt to the first machine learning model includes additional instructions to prevent the misbehavior.

16. The computing device of claim 11, wherein the second machine learning model does not receive the user task.

17. The computing device of claim 11, wherein the second machine learning model receives the user task and instructions to monitor the inner monologue to identify the misbehavior.

18. The computing device of claim 11, wherein the second machine learning model comprises a first number of learned weights that is less than a second number of learned weights of the first machine learning model.

19. The computing device of claim 11, wherein the misbehavior includes one of reward hacking, misgeneralization, sycophancy, and deception.

20. The computing device of claim 11, wherein the reward hacking includes omitting an evaluation of a software development task within the user task.
